(19) United States
(12) Patent Application Publication
(10) Pub. No.: US 2011/0044490 A1
(43) Pub. Date: Feb. 24, 2011

(54) Edge for Speaker

(75) Inventor: Takashi MAKINO, Hamamatsu-shi (JP)

Correspondence Address: CROWELL & MORING LLP;INTELLECTUAL PROPERTY GROUP, P.O. BOX 14300, WASHINGTON, DC, 20044-4300, US

(73) Assignee: YAMAHA CORPORATION, Shizuoka (JP)

(21) Appl. No.: 12/858,263

(22) Filed: Aug. 17, 2010

(30) Foreign Application Priority Data
Aug. 18, 2009 (JP) 2009-189454

(51) Int. Cl. H04R 11/02

(52) U.S. Cl. 381/398

(57) ABSTRACT

An edge is provided between an outer peripheral part of a diaphragm and a frame. The edge includes a concave part which is formed along the outer peripheral part of the diaphragm and which includes a recess. The concave part is comprised of a first material. A second material is filled in a part of the recess and has lower density than the first material.

### BACKGROUND OF THE INVENTION

The present invention relates to an edge for a speaker which is provided around a diaphragm of the speaker.

In a speaker, an outer peripheral part of a diaphragm is connected to a frame of the speaker by an edge. The edge holds the diaphragm of the speaker in a right position, and prevents lateral fluctuation of the diaphragm without disturbing movement of the diaphragm. As material for the edge, the material which is lightweight and excellent in flexibility, and has rigidity against the lateral fluctuation of the diaphragm is preferably used. For example, urethane, rubber, cloth, etc. are used.

When the diaphragm vibrates, resonance may occur at a certain frequency in the edge, in some cases. When the resonance occurs in the edge, a sound different from an object sound to be reproduced may be generated, or the object sound to be reproduced may be attenuated, and as the results, reproducing performance of the speaker is deteriorated. Therefore, it is necessary to restrain occurrence of the resonance.

JP-A-2008-60751 discloses a related art for restraining occurrence of the resonance in the edge. In the related art disclosed in JP-A-2008-60751, the edge is formed by providing two or more kinds of materials having different physical properties, in parallel in a same plane, thereby to disperse resonance points of the edge, and peak/dip which occurs in a middle range and in a high range is suppressed.

In case where the edge has been formed according to the related art disclosed in JP-A-2008-60751, it is possible to suppress the resonance to some extent. However, there has been such a problem that in case where a thickness of the edge is made larger, the edge becomes heavy, and efficiency of the speaker (reproducing performance) is deteriorated, and on the other hand, in case where the thickness of the edge is made smaller, the resonance is likely to occur.

### SUMMARY

It is an object of the invention to provide an edge for a speaker in which occurrence of resonance can be restrained, without adding a work to the edge itself or without changing a thickness of the edge.

In order to achieve the object, according to the invention, there is provided an edge provided between an outer peripheral part of a diaphragm and a frame, the edge comprising a concave part which is formed along the outer peripheral part of the diaphragm and which includes a recess, the concave part comprised of a first material, a second material which is filled in a part of the recess and which has lower density than the first material.

The second material may be filled in an entirety of the recess.

The second material may include expandable material.

The edge may be integrally formed with the outer peripheral part of the diaphragm.

According to the invention, there is also provided a speaker incorporating the edge.

### BRIEF DESCRIPTION OF THE DRAWINGS

FIG. 1A is a sectional view of a dome type speaker provided with a roll edge according to an embodiment of the invention.

FIG. 1B is a back view of a diaphragm, a roll edge and expandable material which are integrally formed (a region surrounded by a dotted line in FIG. 1A).

FIGS. 2A to 2C are enlarged sectional views showing the dome type speaker according to the embodiment of the invention, in a state where the diaphragm rests still and in a state where the diaphragm is vibrating.

FIG. 3 is a graph showing reproducing performances of a related-art dome type speaker and the dome type speaker according to the embodiment of the invention.

FIG. 4 is a sectional view showing a cone type speaker provided with the roll edge according to the embodiment of the invention.

### DETAILED DESCRIPTION OF EMBODIMENTS

Now, a roll edge which is an example of an edge for a speaker according to an embodiment of the invention will be described, referring to a case where the roll edge is applied to a dome type speaker.

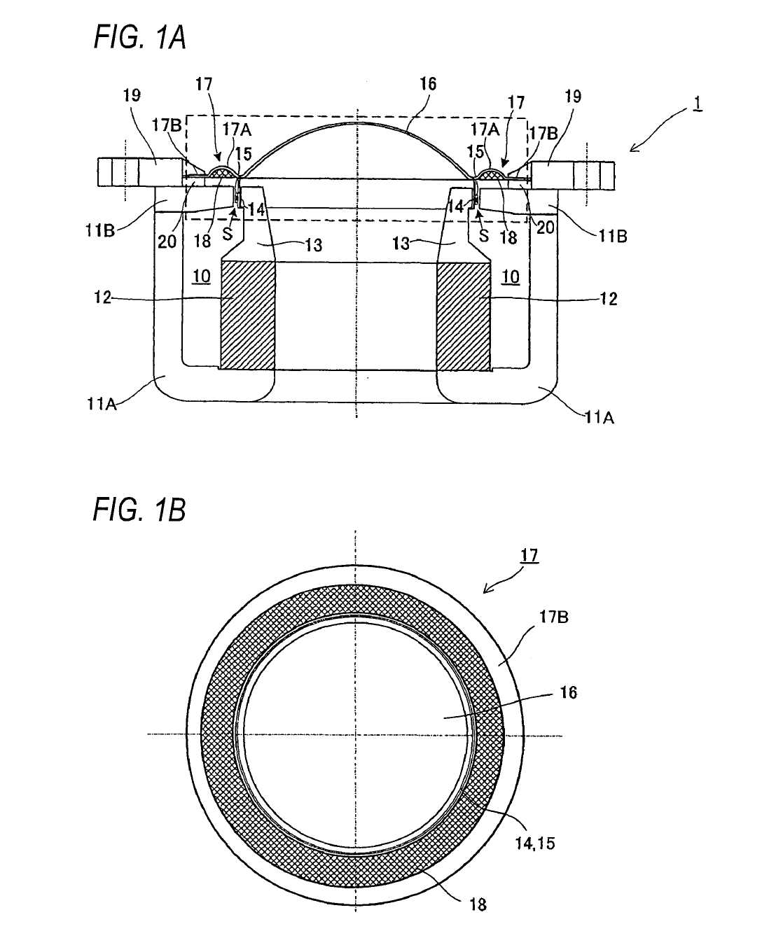

As shown in FIG. 1A, a speaker unit 1 is a dome type speaker, and includes a yoke 11A, a yoke 11B, a magnet 12, a plate 13, a bobbin 14, a voice coil 15, a diaphragm 16, a roll edge 17, expandable material 18, a frame 19, and a packing 20.

The yoke 11A, the yoke 11B, the magnet 12 and the plate 13 constitute a magnetic circuit 10. In the magnetic circuit 10, the voice coil 15 is inserted into a magnetic gap S which is formed between an outer peripheral part of the plate 13 and an inner peripheral part of the yoke 11B. The voice coil 15 is wound around the bobbin 14, and an end of the bobbin 14 is connected to a boundary part between the diaphragm 16 and the roll edge 17.

The diaphragm 16 is formed in a dome-like shape, and the roll edge 17 is connected to an outer peripheral part of the diaphragm 16. The diaphragm 16 vibrates in response to a voice signal inputted from the exterior, and generates sound waves.

The roll edge 17 includes a concave part 17A having an arc-like shape in section which is formed along the outer peripheral part of the diaphragm 16, and a holding part 17B having a flat shape in section. The concave part 17A is formed at the outer peripheral part of the diaphragm 16 and a bottom of the concave part 17A projects in a direction in which a sound is emitted. An inner peripheral part of the concave part 17A is connected to the diaphragm 16, and the holding part 17B is provided on the outer peripheral part of the concave part 17A. As material for the roll edge 17, cloth which has been impregnated with resin and coated thereon with rubber is used. It is also possible to use expandable urethane or the like as the material for the roll edge 17. The holding part 17B is held in a state clamped between the packing 20 in an annular shape which is disposed on the yoke 11B, and the frame 19.

The frame 19 is provided so as to be opposed to the outer peripheral part of the diaphragm 16.

As shown in FIGS. 1A and 1B, the expandable material 18 is filled in the concave part 17A of the roll edge 17. Although expandable urethane which is elastic material having lower density than the roll edge is used as the expandable material 18, it is also possible to use expandable rubber, expandable polyethylene having lower density than the roll edge 17.

The roll edge made of rubber and the expandable urethane to be filled, which are used in this embodiment, have densities of 1.2 g/cm³ and 0.15 g/cm³, respectively. Other expandable materials too have the density of about 0.1 to 0.3 g/cm³. In this manner, by appropriately selecting the expandable material having the density of 1/10 to ⅕ of the density of the roll edge, a drop of sound pressure characteristics due to an increase of weight is restrained.

The expandable material 18 which has been molded in a semicircular shape in advance is fixed to the concave part 17A of the roll edge 17 with an adhesive or the like. Moreover, it is also possible to fill the expandable material in the concave part 17A of the roll edge 17, by expanding the expandable material inside the concave part 17A. It would be preferable that the expandable material 18 is filled in an entireₜy of the concave part 17A. However, it is also possible to fill the expandable material 18 in a part of the concave part 17A, and to pass a cable of the voice coil 15 or so in a part where the expandable material 18 is not filled. As described above, it would be sufficient that the expandable material 18 is simply filled in a recess of the concave part 17A of the roll edge 17, and therefore, the edge can be easily produced, without adding a work to the edge itself or without changing a thickness of the edge.

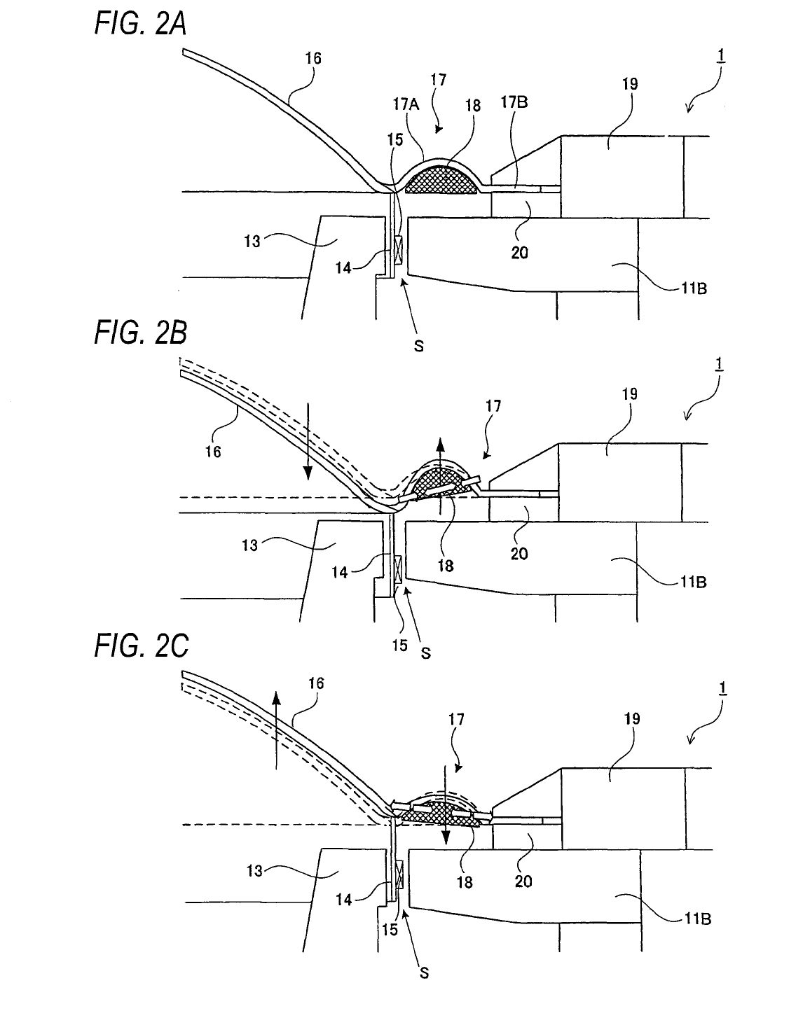

Then, referring to FIG. 2, a state of the speaker unit 1 will be described. FIG. 2A shows a state where the speaker unit 1 rests still, and FIGS. 2B and 2C show a state where the diaphragm 16 is vibrating. In FIGS. 2B and 2C, dotted lines show the diaphragm and the edge while they rest still, as shown in FIG. 2A.

Because the expandable material 18 is provided in the recess of the concave part 17A of the roll edge 17, deformation of the concave part 17A in a lateral direction in the drawings is restrained by the expandable material 18, as shown in FIGS. 2B and 2C. Specifically, when the diaphragm 16 vibrates (moves) in a downward direction, the concave part 17A vibrates (moves) in an upward direction, as shown in FIG. 2B, and a force for deforming the concave part 17A so as to make it smaller in width is applied. However, the expandable material 18 which is filled in the entirety of the concave part 17A resists this force, and resonance components are suppressed, although the concave part 17A and the expandable material 18 are somewhat flexed.

When the diaphragm 16 vibrates (moves) in the upward direction, the concave part 17A vibrates (moves) in the downward direction, as shown in FIG. 2C, and a force for deforming the concave part 17A so as to make it larger in width is applied. However, the expandable material 18 which is filled in the entirety of the concave part 17A resists this force, and the resonance components are suppressed, although the concave part 17A and the expandable material 18 are somewhat flexed.

Because the expandable material 18 acts as described above, the resonance of the roll edge 17 can be suppressed, when the diaphragm 16 vibrates. In this manner, when the diaphragm 16 vibrates, generation of a sound which is different from an object sound to be reproduced, due to the resonance of the roll edge 17, can be restrained, and hence, bad influence on the reproducing performance of the speaker unit will be eliminated.

Moreover, in case where the same material as the roll edge 17 or material having higher density than the roll edge 17 has been used as the expandable material 18, the weight of the roll edge 17 is increased, and the movement of the diaphragm 16 in a vertical direction is worsened. As the results, the reproducing performance of the speaker unit 1 is deteriorated. Therefore, according to an aspect of the invention, the elastic material having lower density than the roll edge 17 is used as the expandable material 18, for the purpose of restraining deterioration of the reproducing performance of the speaker unit 1, by reducing the weight of the expandable material 18 itself.

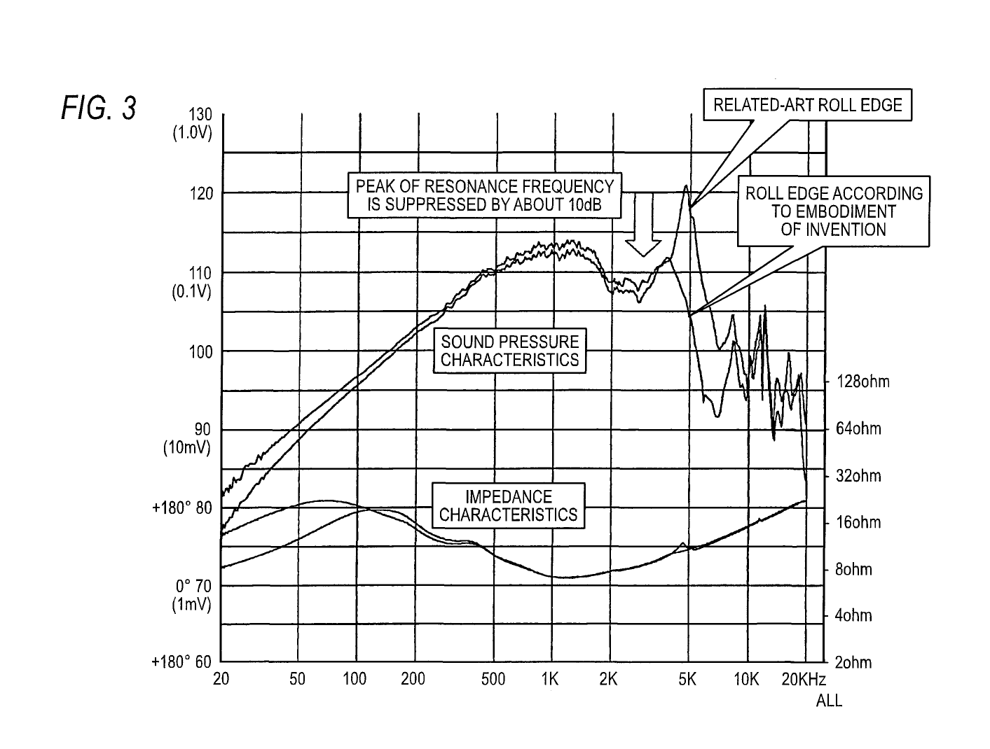

Advantage of filling the expandable material 18 in the roll edge 17 will be described referring to FIG. 3. FIG. 3 shows sound pressure characteristics and impedance characteristics of the speaker, in case where the expandable material 18 is fitted to the recess of the concave part 17A of the roll edge 17, and in case where the expandable material 18 is not fitted to the recess of the concave part 17A. As shown in FIG. 3, in case of the related-art speaker unit which is not provided with the expandable material 18, a peak of resonance appears in proximity of 5 kHz. On the other hand, in the speaker unit 1, a peak of the resonance which appears in proximity of 5 kHz is suppressed by about 10 dB. Concerning the impedance characteristics too, although a peak occurs at about 5 kHz in the related-art speaker unit, a peak does not occur at about 5 kHz in the speaker unit 1.

In this manner, by providing the expandable material 18 in the concave part 17A of the roll edge 17, the resonance of the roll edge 17 can be suppressed, without adding a work to the edge itself, or changing the thickness of the edge, and the reproducing performance of the speaker unit can be improved.

Moreover, because the expandable material 18 is employed as the material to be filled in the recess of the concave part 17A, as described above, in case where the roll edge according to the embodiment of the invention is used, a drop of the sound pressure characteristic of the speaker unit in a range of 20 Hz to 3 kHz in FIG. 3 is suppressed to the least. In case where the same material as the material used for the concave part 17A or the material having higher density is used as the material to be filled in the concave part 17A, the sound pressure characteristic of the speaker unit remarkably drops.

The roll edge according to the embodiment of the invention is not only applied to the dome type speaker, but can be, of course, applied to other speakers using the roll edge.

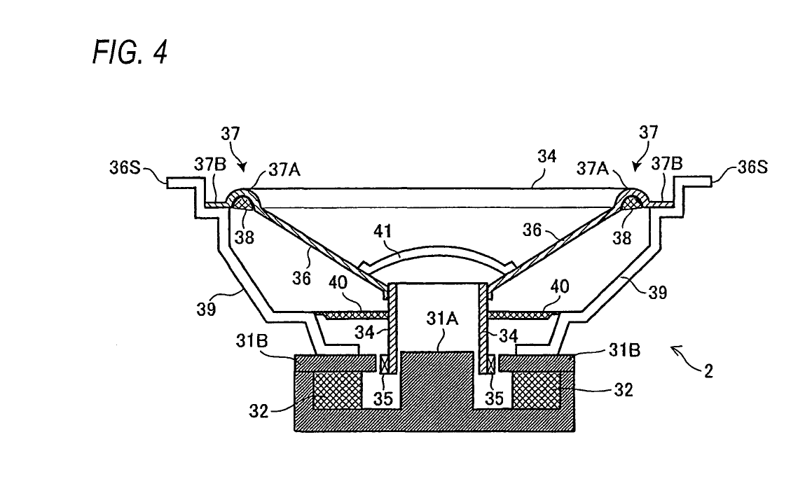

For example, a case where the roll edge according to the invention is applied to a cone type speaker is shown in FIG. 4. As shown in FIG. 4, the speaker unit 2 is a cone type speaker and includes a yoke 31A, a yoke 31B, a magnet 32, a bobbin 34, a voice coil 35, a diaphragm 36, a roll edge 37, expandable material 38, a frame 39, a damper 40, and a dust cap 41.

The yoke 31A, the yoke 31B, and the magnet 32 constitute a magnetic circuit 30. In the magnetic circuit 30, the voice coil 35 is inserted into a magnetic gap S which is formed between an outer peripheral part of a pole of the yoke 31A and an inner peripheral part of the yoke 31B. The voice coil 35 is wound around the bobbin 34, and an edge of the bobbin 34 is connected to an inner peripheral part of the diaphragm 36.

The diaphragm 36 is formed in a cone-like shape, and the roll edge 37 is connected to an outer peripheral part of the diaphragm 36.

The roll edge 37 includes a concave part 37A having an arc-like shape in section, and a holding part 37B having a flat shape in section. An inner peripheral part of the concave part 37A is connected to the diaphragm 36, and the holding part 37B is provided on an outer peripheral part of the concave part 37A. The holding part 37B is bonded to the frame 39. The damper 40 is connected to the bobbin 34 and the frame 39. The dust cup 41 covers an upper opening of the bobbin 34, having its outer peripheral part connected to the diaphragm 36.

In case of the cone type speaker too, when the diaphragm vibrates, resonance occurs in the same manner as in the dome type speaker. Therefore, in the speaker unit 2, the expandable material 38 is filled in a recess of the concave part 37A, in the same manner as in the speaker unit 1.

As the results, the resonance of the roll edge 37 is suppressed in the same manner as in the dome type speaker, and the reproducing performance of the speaker unit 2 can be improved.

Moreover, the invention is not only applied to the dome type speaker and the cone type speaker, but also can be applied to all the speakers using the roll edge.

Further, the invention is not only applied to the roll edge, but can be applied to other edges having the concave part. For example, the invention can be applied to a V edge, a corrugation edge, a multiple half roll cross edge, an accordion pleats cross edge, a one piece fixed edge, and so on. The invention can be also applied to a fixed edge in which a diaphragm and an edge are integrally molded of the same material, and to a free edge in which an edge is bonded to an outer peripheral part of a diaphragm.

According to an aspect of the invention, because the material is filled in the recess of the concave part of the edge for the speaker, deformation of the concave part due to the resonance of the edge, while the diaphragm is vibrating, is suppressed by the material which has been filled. As the results, resonance components of the edge are suppressed, and reproducing performance of the speaker can be improved. Moreover, because it would be sufficient that the material is simply filled in the recess of the concave part of the edge, the edge can be easily produced, without adding a work to the edge itself, or without changing a thickness of the edge. Further, as the material to be filled in the recess of the concave part, the material having lower density than the concave part is used. As the results, increase of weight of the edge can be restrained, and it is possible to maintain the edge at a light weight.

According to an aspect of the invention, because the material having the lower density is filled in an entirety of the concave part, it is possible to restrain deformation of the concave part in the entirety of the concave part, when the resonance occurs in the edge. Therefore, the resonance components of the edge are suppressed, and the reproducing performance of the speaker can be further improved.

According to an aspect of the invention, the expandable material is filled in the recess of the concave part of the edge as the material having the lower density. The expandable material contains a plurality of bubbles, and hence, the weight of the entire edge can be made lightweight. Moreover, because the bubbles serve as shock absorbing material, deformation of the edge is restrained. As the results, the resonance components of the edge are suppressed, and the reproducing performance of the speaker can be improved.

According to an aspect of the invention, when the diaphragm vibrates, the resonance of the edge is suppressed, and hence, the reproducing performance of the speaker unit can be improved, without adding a work to the edge itself, or without changing the thickness of the edge.

What is claimed is:

1. An edge provided between an outer peripheral part of a diaphragm and a frame, the edge comprising a concave part which is formed along the outer peripheral part of the diaphragm and which includes a recess, the concave part comprised of a first material, a second material which is filled in a part of the recess and which has lower density than the first material.

2. The edge according to claim 1, wherein the second material is filled in an entirety of the recess.

3. The edge according to claim 1, wherein the second material includes expandable material.

4. The edge according to claim 1, integrally formed with the outer peripheral part of the diaphragm.

5. A speaker incorporating the edge according to claim 1.
